(19) United States
(12) Patent Application Publication
(10) Pub. No.: US 2023/0066556 A1
(43) Pub. Date: Mar. 2, 2023

(54) METHODS, SYSTEMS, AND APPARATUSES FOR PERFORMING ELECTROCHEMICAL MACHINING USING DISCRETIZED ELECTROLYTE FLOW

(71) Applicant: Voxel Innovations, Inc., Raleigh, NC (US)

(72) Inventors: Daniel HERRINGTON, Raleigh, NC (US); Eric ROUNTREE, Raleigh, NC (US)

(21) Appl. No.: 18/048,273

(22) Filed: Oct. 20, 2022

Related U.S. Application Data
(63) Continuation of application No. PCT/US21/28895, filed on Apr. 23, 2021.
(60) Provisional application No. 63/015,419, filed on Apr. 24, 2020.

(51) Int. Cl. C25D 17/12; C25D 5/08

(52) U.S. Cl. CPC C25D 17/12; C25D 5/08

(57) ABSTRACT

A discretized-flow electrode for use in electrochemical machining (ECM) and a corresponding method and system for using the discretized-flow cathode are disclosed. The machining face of the discretized-flow cathode is divided into a plurality of discrete sections. The discrete sections may be geometrically shaped, and they are separated at the machining face by an electrolyte flow outlet channel, and each discrete section includes an electrolyte flow inlet local to the discrete section. The plurality of discrete sections of the machining face of the discretized-flow electrode divide the electrolyte flow into approximately equal portions for even electrolyte flow across the machining face.

### CROSS-REFERENCE TO RELATED APPLICATIONS

This application is a continuation of International Patent Application No. PCT/US21/28895 filed on Apr. 23, 2021 by Voxel Innovations, Inc., entitled “METHODS, SYSTEMS, AND APPARATUSES FOR PERFORMING ELECTROCHEMICAL MACHINING USING DISCRETIZED ELECTROLYTE FLOW”, which claims priority to U.S. Provisional Patent Application No. 63/015,419 filed on Apr. 24, 2020 by Voxel Innovations, Inc., entitled “METHODS, SYSTEMS, AND APPARATUSES FOR PERFORMING ELECTROCHEMICAL MACHINING USING DISCRETIZED ELECTROLYTE FLOW,” the entire contents of all of which are incorporated by reference herein.

### GOVERNMENT SUPPORT

This invention was made with U.S. Government support under Contract No. N6833518C0827, a Small Business Innovative Research (SBIR) Phase I contract, awarded by the Department of Defense. The Government has certain rights in the invention.

### TECHNICAL FIELD

The field of the invention relates generally to the methods, systems, and apparatus for performing electrochemical machining using tools with discretized electrolyte flow. More specifically, the field of the invention relates to creating an electrode that includes a plurality of electrolyte flow inlets and electrolyte flow outlet channels to provide discretized, uniform, electrolyte flow.

### BACKGROUND

Electrochemical machining (ECM) and its recent successor, pulsed electrochemical machining (PECM), are material-removal techniques based upon the anodic dissolution of metal into a neutral electrolyte. ECM is known for its high material-removal rate, superior surface quality, non-contact processing, and the ability to operate on many challenging metal alloys.

ECM is used within the commercial turbine and automotive engine industries where components are both high-volume and high-value and can therefore support the capital required for process development to attain the benefits provided by ECM. For example, although components for use in the defense industry are high value, their volumes are low, necessitating a lower total cost ECM solution to satisfy the needs of lower rate production operation. One challenge to greater adoption of ECM is the tooling development cost, which is a barrier-to-entry as initial prototypes are expensive, and much of the manufacturing cost is up-front, representing a substantial risk if the product does not meet volume targets. Additionally, if the intended part volumes are low, amortization of the tooling-development costs drives the final per-part price above other competing technologies.

In short, ECM is valuable, but it is underutilized because of the economics of the process, especially in applications with low annual production volumes. The cost for developing tooling for an ECM-based production process can be high, depending on the complexity and tolerances of the component. Thus, when small components are produced at low volume, pricing is driven by tooling development. This large expense is a significant risk.

Thus, there is a need for ECM tooling with a low tool-design cost and better performance characteristics than traditional ECM tooling.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The invention described herein relates generally to methods, systems, and apparatuses for performing electrochemical machining (ECM) using electrodes that provide discretized flow of electrolyte used for processing a workpiece using an ECM process. More specifically, the field of the invention relates to creating an electrode that includes a plurality of electrolyte flow inlets and electrolyte flow outlet channels to provide discretized electrolyte flow. Such an electrode is referred to herein as a discretized-flow electrode. The discretized-flow tools and techniques for ECM operations described herein provide both performance benefits and costs savings to the traditional ECM process.

### BRIEF DESCRIPTION OF THE DRAWINGS

FIG. 1 shows a prior-art traditional center-flow cathode that uses a single source electrolyte that must be distributed over the entire machining face.

FIG. 2A shows a discretized-flow electrode.

FIG. 2B shows an embodiment of a hexagonal machining face of a discrete section of an exemplary discretized-flow cathode.

FIG. 3A shows a zoomed-in view of the machining face of a 3D-printed flow-discretization cathode with no porous material (the flow-discretization cathode of FIG. 2A).

FIG. 3B shows a zoomed-in view of the machining face of a 3D-printed flow-discretization cathode with porous material, otherwise referred to as a porous flow-discretization cathode.

FIG. 4 shows electrolyte flow from the exemplary discretized-flow cathode shown in FIG. 2A.

FIG. 5 shows a cross-sectional view of an electrolyte flow inlet sourcing fluid from the plenum, which is internal to the tool, then to the machining face, and then out the rectangular exit channels.

FIG. 6 provides an exemplary process flowchart for performing discretized-flow ECM.

FIG. 7A shows a flow cavity for showing how 3D-printed pores respond to an uneven anode surface and the flow velocity through each of the seven pores.

FIG. 7B shows a flow cavity for showing how micro EDM produced pores respond to an uneven anode surface and the flow velocity through each of the seven pores.

FIG. 8 shows a volume fraction of gas due to cavitation of the electrolyte as it exits the micro EDM pores shown in FIG. 7B.

FIG. 9A shows a comparison of the final workpiece surface for ECM using a traditional center-flow cathode and ECM using the discretized-flow cathodes described herein using 20V DC power, a 200 μm targeted machining gap, and a 2.5 lpm flow volume.

FIG. 9B shows a comparison of the final workpiece surface for ECM using a traditional center-flow cathode and ECM using the discretized-flow cathodes described herein using 20V DC power, a 200 μm targeted machining gap, and a 1.5 lpm flow volume.

FIG. 10 shows a comparison of the final workpiece surface for a traditional center-flow cathode and a discretized-flow cathode described herein using pulsed power, a 100 μm targeted machining gap, and 2 lpm flow volume.

FIG. 11 shows a comparison of the final workpiece surface for a traditional center-flow cathode and a discretized-flow cathode using pulsed power, a 100 μm targeted machining gap, and 2 lpm flow volume with a 1.5-degree angle between the cathode machining face and the workpiece surface.

FIG. 12 shows an IBR-producing discretized-flow cathode with a hexagonal flow-discretization pattern.

FIGS. 13A and 13B shows an exemplary workpiece that is cut as compressor IBR blades using a multi-faceted cathode with a single tool and no added flow fixturing.

FIG. 14 shows a fixture for the pieces shown in FIGS. 12 and 13A-13B.

FIG. 15A shows an exemplary 3D-printed discretized-flow roughing cathode from a first perspective.

FIG. 15B shows an exemplary 3D-printed discretized-flow roughing cathode from a second perspective.

### DETAILED DESCRIPTION

The presently disclosed subject matter is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Disclosed herein are methods, systems, and apparatuses for performing an electrochemical machining process using an electrode that provides discretized flow of electrolyte used for processing a workpiece.

Tool design in ECM tool development is primarily influenced by the need for proper distribution and control of the electrolyte. The flow of electrolyte (or lack thereof) dictates the machining rate (i.e., uneven flow gives uneven machining). Some irregularity in the flow across the machining zone exists because of the complexity of the components that are produced using ECM. This can be mitigated by vibrating the machining axis to distribute the electrolyte or the use of high electrolyte pressures; however, vibration to distribute the electrolyte results in a significantly slowed process. High electrolyte pressures require complex and robust process fixturing and contributes significantly to the cost of tool design.

Alternative approaches to providing discretized flow in traditional ECM tooling have been proposed. For example, EP2555898 discloses an ECM tool in which the electrolyte is supplied to the surface at an inner region of the active surface and removed from the surface at the edge region of the active surface. Both the supply and removal channels are perpendicular to the active surface. Similarly, EP2435205 discloses an ECM tool in which the electrolyte exchange is provided between the electrode and the workpiece. As with in EP2555898, the feed channels and return channels disclosed in EP2435205 extend substantially parallel to one another and parallel to the feed direction, which is perpendicular to the machining face or active surface.

In the discretized-flow electrode described herein, the electrolyte outlet or exit channels are not separate, discrete exit channels. Instead, the exit channels of the discretized-flow electrode described herein provide a continuous pathway at the surface of the electrode, at the inter-electrode gap. Thus, the exiting electrolyte generally flows parallel to the machining face and the workpiece surface as it exits the inter-electrode gap, as opposed to flowing perpendicular to the surface as it exits the inter-electrode gap, as disclosed in the other systems. The continuous exit channels described herein are more robust and are not prone to lack of flow in particular areas, which is a problem found in the other systems. Additionally, it is somewhat infeasible to manufacture an electrode tool with the outlets being separate, discrete outlets that flow substantially parallel to the inlet channels because the packaging of those features leads to a smaller outlet area, which may not be desirable. In contrast, the discretized-flow electrode described herein uses a parallel-to-the-surface approach for the outlet or exit channels, which allows for the outlet regions to completely envelope the inlet area, which is preferable for the ECM process. The discretized-flow electrode design disclosed herein is significantly more manufacturable. Additionally, when the separate inlets and outlets run parallel to one another, as in the other systems, it is a significant challenge to connect all of them, which generally means the electrode gets bigger, thereby limiting its utility where electrode access is a challenge. In contrast, with the discretized-flow electrode described herein, feeding electrolyte to all of the inlets is achieved with a single manifold, while all of the outlets exhaust into the chamber, with no extra return manifold needed. For at least these reasons, the discretized-flow electrode described herein with the outlet channels forming a continuous pathway at the surface to allow the exiting electrolyte to flow generally parallel to the machining surface has significant advantages over the parallel-to-inlet-channel approach from both a theoretical performance perspective and a practical perspective.

For the discretized-flow electrode described herein, electrolyte may be distributed through via passages within the tool. Passages may be incorporated into the tool using metal 3D-printing, also referred to as additive manufacturing (“AM”), prepared through conventional machining operations, or incorporated using small diameter metal tubing. As described herein, additive manufacturing may be used to generate tools that allow electrolyte to be selectively applied where it is needed, directly into the machining gap, through the machining face of the tool. This incorporation of electrolyte flow from within the machining gap has two major effects on the tool design process: (1) sourcing the electrolyte from within the gap eliminates the need for the complex fixturing that is common in ECM for directing the pressurized electrolyte into the gap, which saves time in the design phase and significant equipment in the fabrication phase; and (2) the more even distribution of the electrolyte increases the first-pass machining accuracy and thereby reduces the number of design iterations required.

The versatility in electrolyte distribution provided by the discretized-flow tools and techniques described herein increases machining accuracy of the ECM tool, reduces the ECM tool design complexity, and lowers the tool manufacturing cost, all of which help reduce the total ECM tooling cost. The end result is improved functionality (i.e., fewer design iterations, faster processing speed) combined with a lower cost of the individual design and testing steps, hitting both of the targets for a more economical ECM tool design process.

The discretized-flow tools and techniques described herein reduce the cost of the ECM tooling and enable the tool to enhance/optimize the electrolyte delivery for complex geometry components. Discretized-flow represents an alternative electrolyte management paradigm, whereby the electrolyte is managed in the machining zone over short distances (0.25-2 mm), creating uniform electrolyte conditions across the machining gap, and local electrolyte conditions that are unaffected by downstream or upstream metal dissolution.

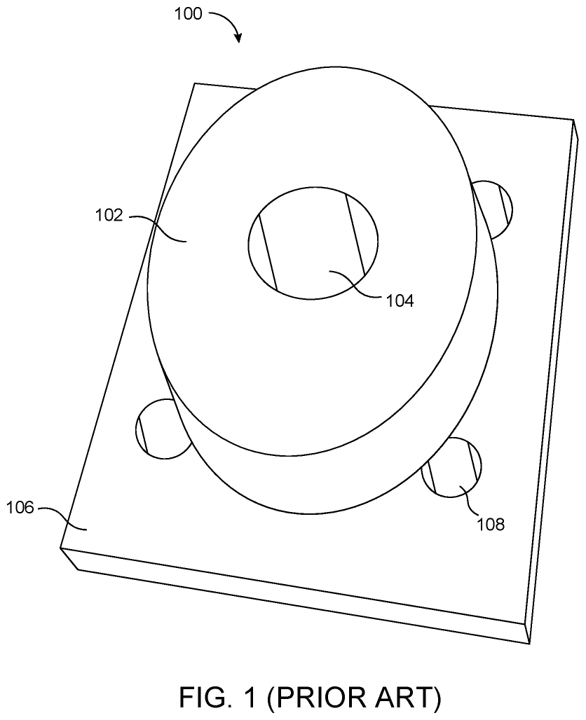

FIG. 1 shows a prior-art traditional center-flow cathode that uses a single source electrolyte that must be distributed over the entire machining face. Such a traditional cathode as shown in FIG. 1 may be referred to as a center-flow electrode.

Referring to FIG. 1, the center-flow electrode 100 comprises a machining face 102 and an electrolyte supply channel 104. The electrode 100 further includes a base plate 106 with fixturing holes 108 for mounting to an ECM machine.

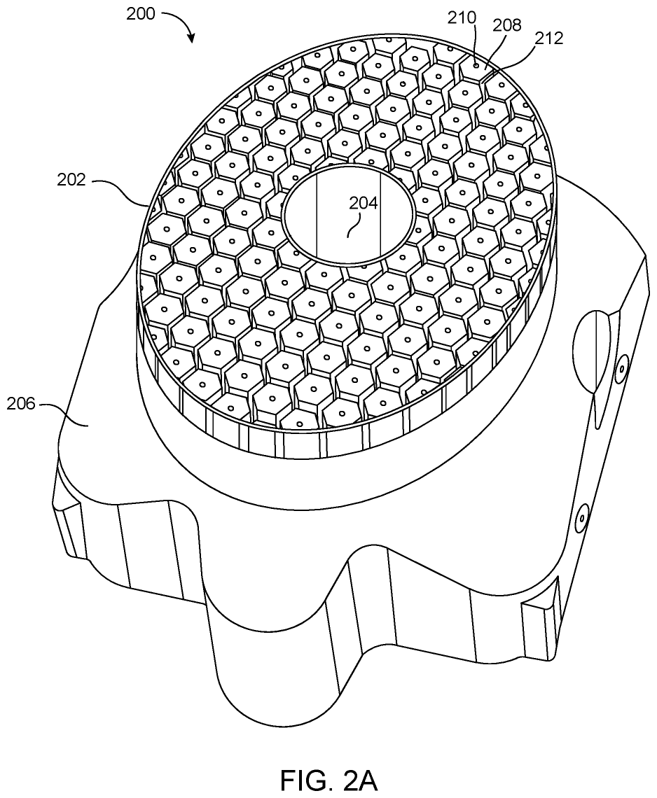

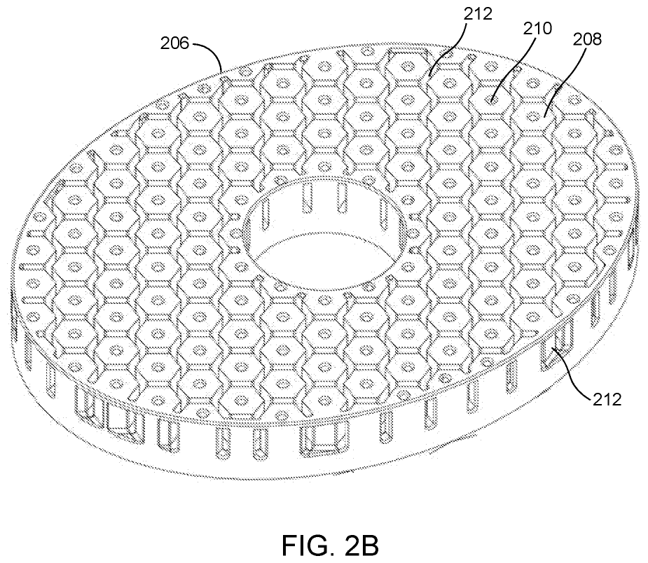

FIG. 2A shows a discretized-flow electrode. Referring to FIG. 2A, the machining face 202 of the discretized-flow electrode 200 shown in FIG. 2A is divided into multiple discrete sections (or portions), which, as shown in FIG. 2A, form a hexagonal grid, with the flow being sourced from an electrolyte flow inlet 210 in each hexagon 208 and allowed to escape through an electrolyte flow outlet channel 212 (or electrolyte exit channel or viae) that runs between each section 208 (or “island”). In accordance with the subject matter disclosed herein, a discretized-flow electrode 200 for performing ECM may comprise a machining face divided into a plurality of discrete sections 208. The discrete sections are separated at the machining face by an electrolyte flow outlet channel 212. Each discrete section includes an electrolyte flow inlet 210. The discretized-flow electrode 200 comprises an electrolyte source in fluid communication with the electrolyte flow inlets 210 for supplying electrolyte to the electrolyte flow inlets 210 in the discrete section via electrolyte flow passages internal to the discretized-flow electrode 200. The discrete sections 208 may be geometrically shaped sections (such as, for example, the hexagonal shaped sections shown in FIG. 2A). In various embodiments, the discrete sections 208 may each be of the same or similar shapes as one another, or the discrete sections 208 may vary in shape relative to one another depending on the particular use case of the discretized-flow electrode. The discrete sections may be polygonal in shape, such as hexagonal, octagonal, triangular, rectangular (or square), elliptical (or circular), or the like.

The electrolyte flow holes 210 may be referred to as electrolyte flow inlets or flow inlets, depending on the context. Although the electrolyte flows out of the ECM tool, the flow holes are referred to as inlets because they allow electrolyte into the ECM chamber and into the machining gap between the electrode and the workpiece. Similarly, the electrolyte flow outlet channels 212 may be referred to as grooves or exit channels (e.g., hexagonal grooves or hexagonal channels). The electrolyte exit channels 212 allow electrolyte and/or gaseous hydrogen waste product (or both) to flow out of the ECM chamber and out of the machining gap. The outlet channels 212 may accept electrolyte and the waste products of heat, dissolved metal, and gas, or they may accept only the gas, depending on the configuration of the ECM tool and/or the parameters of the process being used. As explained above, the exit channels separate the inlet portions and run generally parallel to the machining face such that the electrolyte and/or waste flowing away from the machining gap flows approximately parallel to the machining surface. The exit channels provide a continuous pathway at the machining face for exit of the waste.

In the embodiment shown in FIG. 2, the electrolyte exit channel 212 is approximately 3 mm deep. The discrete sections or islands 208 are approximately 2 mm in cross-section with the central flow hole 210 being approximately 0.5 mm in diameter and the channels between sections or islands being approximately 0.5 mm wide. In other embodiments, other patterns and/or dimensions may be used, depending on the nature of the discretized-flow electrode being used. For example, in some situations, the geometrically shaped sections may vary in size and/or shape, and there may be more or fewer of them relative to the size of the machining face.

In the embodiment shown in FIG. 2A, each discrete section 208 includes an electrolyte flow inlet 210 (which may be referred to as a local flow inlet), and each electrolyte flow inlet is the same size and shape. In other embodiments, however, some or all of the discrete sections 208 may include more than one electrolyte flow inlets 210. For example, some discrete sections may include a single inlet, while other discrete sections include multiple inlets, depending on the shape, size, and needs of the particular electrode. Similarly, the size and/or shape of the electrolyte flow inlets 210 may vary across different discrete sections 208 of the same discretized-flow electrode 200. For example, some discrete sections may include smaller inlets while other discrete sections include larger inlets, and the inlets may have different shapes.

In the embodiment shown in FIG. 2A, the discretized-flow electrode 200 is 3D-printed using stainless steel 316. In other embodiments, other materials may be used, for example, conductive material, depending on the nature of the discretized-flow electrode being printed.

FIG. 2B shows an embodiment of a hexagonal machining face of a discrete section of an exemplary discretized-flow cathode. In some embodiments, the discretized-flow tools and techniques use a flow surface divided into sections forming a hexagonal pattern, whereby each hexagon 208 acts as an independent entity, having its own flow in from flow inlet 210 and flow out from exit channel 212.

The pattern and/or the geometry of the sections of the machining face of the discretized-flow cathode may be affected by (1) the diameter of the electrolyte flow inlet (or hole) providing electrolyte flow to the inter-electrode gap; (2) the volume of the electrolyte flow outlet (e.g., channel, groove) allowing electrolyte flow to exit the machining area; and (3) the flow length between the electrolyte inlet and the electrolyte outlet. Uniformity from one discrete zone to the next may be improved by decreasing the diameter of the electrolyte flow inlet hole leading into the inter-electrode gap, and by increasing the volume of the electrolyte flow outlet leading out of the machining area. As the pressure drop from the source to the surface becomes larger, the deviation from one discrete zone to the next becomes less significant. In one embodiment, the minimum feature size is 0.5 mm for commercially available solutions.

In traditional ECM, uneven or evolving IEG may cause the electrolyte flow to stall in areas where the greatest material removal rate is needed due to the decreasing flow area and increasing machining induced pressure. Utilizing the discretized-flow electrode described herein, this issue is largely alleviated as irregularities across the machining area at large do not affect the local condition. In the event that the desired machining gap is sufficiently small, it is possible to strangle the flow locally. One way to solve this problem is to make the flow hole significantly smaller to induce a larger pressure drop prior to the machining gap. Another way to solve this problem is to print the electrolyte inlet passages sealed, and then open the passages using an EDM, laser drilling methods, or any other contact or non-contact subtractive metal-removal techniques. Cavitation of the electrolyte, which may be harmful to the ECM process, may be mitigated by recessing the restricting electrolyte pore such that the fluid has regained stability by the time it reaches the machining face.

In various embodiments, the discretized-flow electrode 200 shown in FIGS. 2A and 2B may be used with pure DC ECM for performing a roughing operation, or it may be used with pulsed ECM for performing a semi-finishing operation, or it may be used with pulsed ECM with an uneven workpiece surface.

In one embodiment, to avoid undesirable surface artifacts that may result from sourcing the electrolyte from the machining face of the discretized-flow electrode 200, the workpiece may be oscillated during the ECM process in directions that are perpendicular to the machining direction to delocalize the artifacts. For example, the z-axis may be used as a sinking axis for machining, and a circular motion path with a radius of 200 μm may be imparted on the x-y plane. This motion delocalizes the flow artifacts over a 400 μm area, dampening their appearance. In other embodiments, the oscillation may occur along one or more axes. For example, the oscillation of the electrode 200 relative to the workpiece may be performed in any of the X, Y, and/or Z axes, as well as the A, B, and/or C rotational axes, or any combination thereof.

In other embodiments, to avoid undesirable surface artifacts that may result from sourcing the electrolyte from the machining face of the discretized-flow electrode 200, the flow-discretization electrode 200 may be printed using a porous 3D-printing technique to provide extra surface area for machining, which provides the added benefit of increasing the pressure drop through the cathode and thus more uniformly distributing the electrolyte. The electrolyte inlet and exit area of the flow-discretization cathode may be filled with porous media. In such embodiments, the inlets may have a relatively large pressure drop while the exits are essentially free flowing. Different parameter sets may be used to print the porous area to provide different pressure drop options.

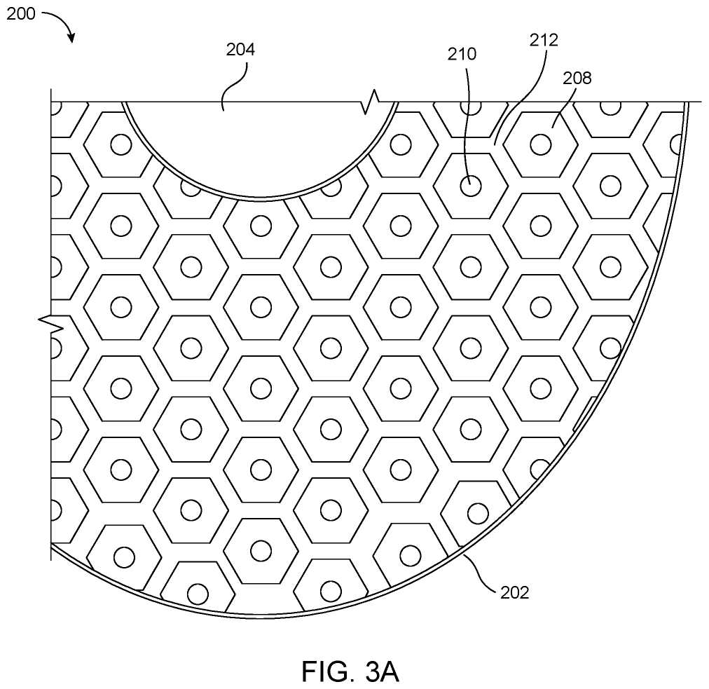

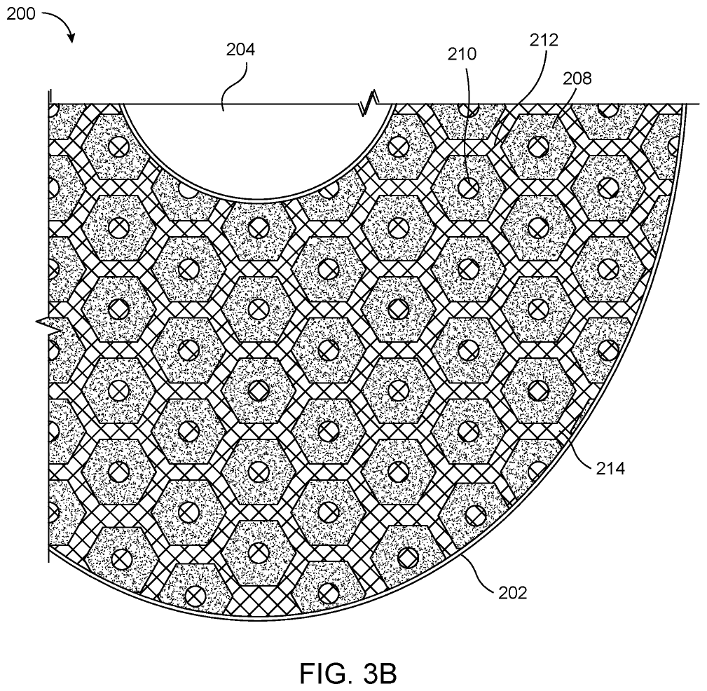

FIG. 3A shows a zoomed-in view of the machining face 202 of a 3D-printed flow-discretization cathode 200 with no porous material (the flow-discretization cathode 200 of FIG. 2A).

FIG. 3B shows a zoomed-in view of the machining face 202 of a 3D-printed flow-discretization cathode 200 with porous material 214 (indicated with cross-hatching), otherwise referred to as a porous flow-discretization cathode. As an alternative to EDM or laser drilling, porous flow passages may be created in an otherwise fully dense component. The porosity may be tuned to each application such that a dense section may be printed for the electrolyte inlet pores and a loose section may be printed for the electrolyte outlet section to maintain discretization while also having a fully continuous conductive surface.

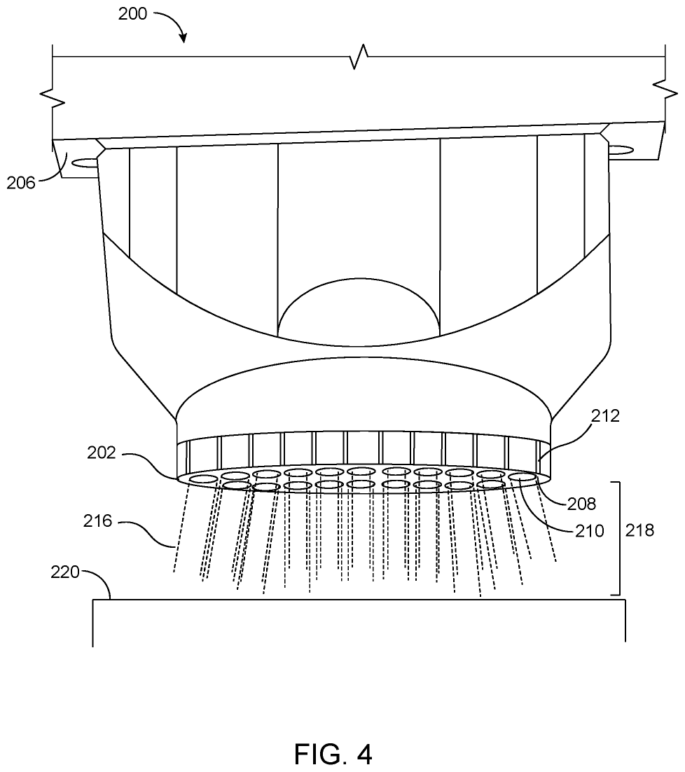

FIG. 4 shows electrolyte flow from the exemplary discretized-flow cathode shown in FIG. 2A. Referring to FIG. 4, electrolyte 216 flows from the inlet 208 into the machining gap 218. The machining surface or workpiece surface 220 is opposite the electrode machining face 202.

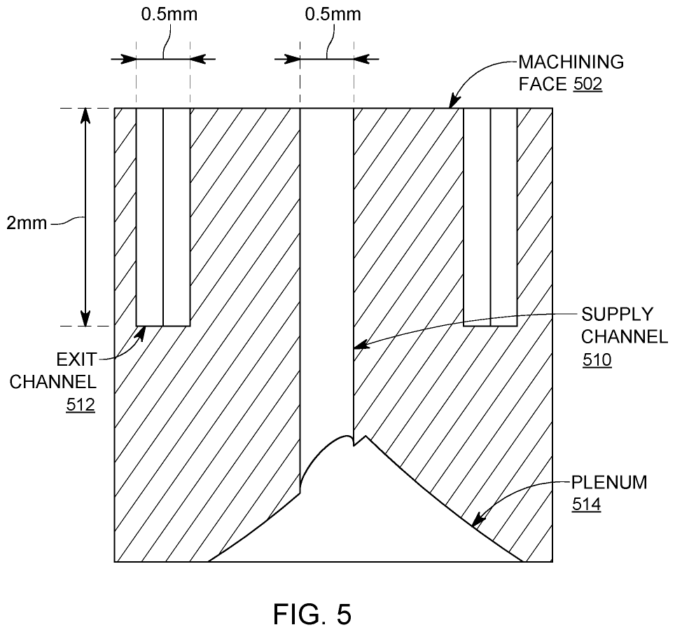

FIG. 5 shows a cross-sectional view of an electrolyte flow inlet sourcing fluid from the plenum, which is internal to the tool, then to the machining face, and then out the rectangular exit channels. Referring to FIG. 5, the electrode includes an internal plenum 514 that distributes the electrolyte to the various inlet ports or supply channels 510, which then send the electrolyte out to the machining face 502. As can be seen in the cross-sectional view shown in FIG. 5, the exit channel 512 provides a separate path for the electrolyte to exit the tool. The exit channel 512 routes the electrolyte out the side of the tool, as can be seen, for example, in FIG. 2B.

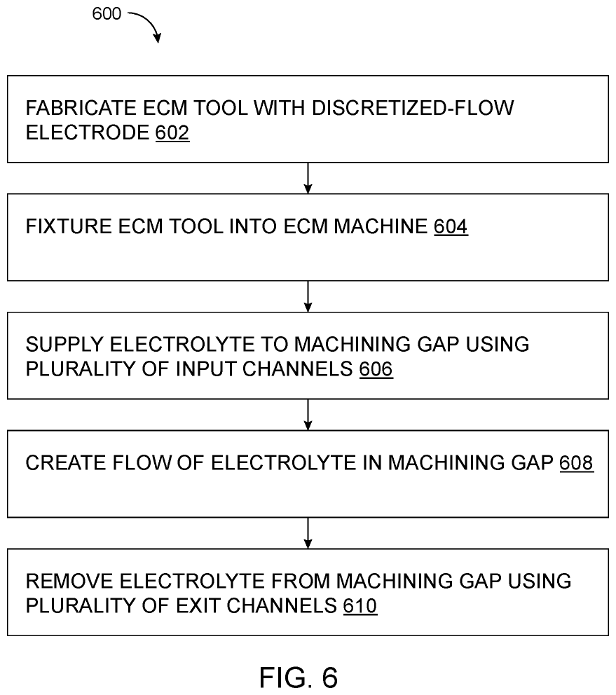

The discretized-flow tools and techniques disclosed herein include a method of performing discretized-flow ECM. FIG. 6 provides an exemplary process flowchart for performing discretized-flow ECM. Referring to FIG. 6, in the method 600 of performing discretized-flow ECM, an ECM tool comprising a discretized-flow electrode is fabricated at step 602. In some embodiments, the ECM tool is fabricated using additive manufacturing. The discretized-flow electrode includes a machining face divided into a plurality of discrete sections. The discrete sections include a local electrolyte flow inlet and a local electrolyte flow outlet channel that separates the discrete sections at the machining face. The discrete sections may be geometrically shaped sections. The ECM tool is fixtured into an ECM machine at step 604. The ECM tool may be mounted using a fixturing plate. The ECM tool is positioned such that the machining face of the discretized-flow electrode is positioned to create a machining gap for processing a workpiece. In some embodiments, the ECM tool is positioned such that the inter-electrode gap between the machining face of the ECM tool and the surface of the workpiece is a uniform thickness. In other embodiments, the inter-electrode gap may not be uniform. The workpiece is processed using the ECM machine with the ECM tool fixed into the ECM machine. Electrolyte is circulated from an electrolyte source to the machining gap through the local electrolyte flow inlet (step 606) and out through the local electrolyte flow outlet channel (step 610). The electrolyte flows from an electrolyte source and out of the ECM tool through the electrolyte flow inlets into the machining gap at step 606. The electrolyte flows in the machining gap to perform the discretized-flow ECM processing, at step 608. The electrolyte exits the machining gap through the electrolyte flow outlets or exit channels at step 610. The electrolyte source may be one or more electrolyte reservoirs, or it may be an electrolyte supply line that feeds electrolyte to the ECM tool.

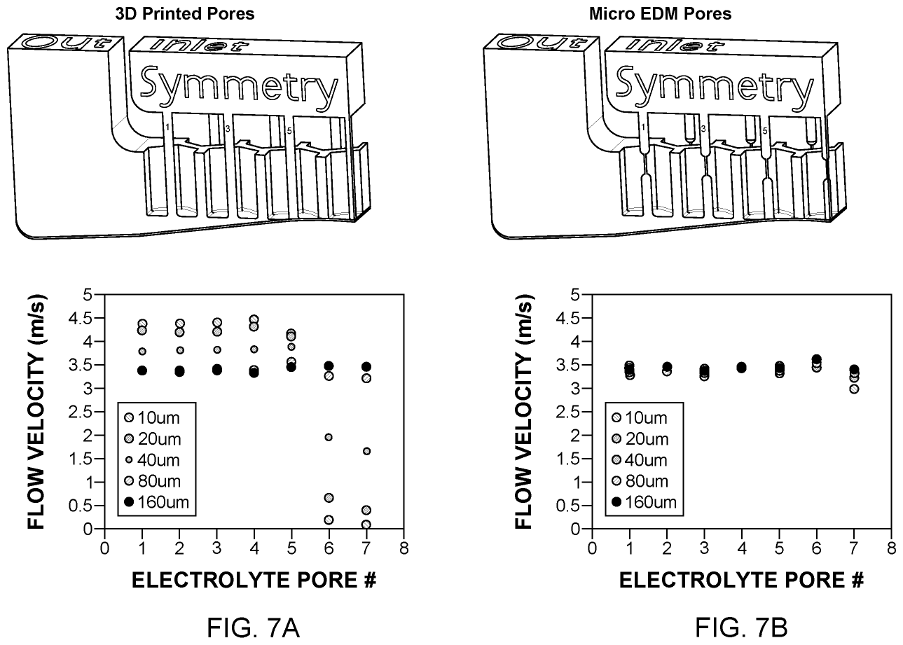

FIG. 7A shows a flow cavity showing how 3D-printed pores respond to an uneven anode surface (shown on the top of FIG. 7A) and the flow velocity through each of the seven pores (shown on the bottom of FIG. 7A).

FIG. 7B shows a flow cavity showing how micro EDM produced pores respond to an uneven anode surface (shown on the top of FIG. 7B) and the flow velocity through each of the seven pores (shown on the bottom of FIG. 7B).

As shown in the flow velocity plots of FIGS. 7A and 7B, the flow through the 3D printed pores is highly dependent upon the gap, whereas flow through the micro EDM pores is unaffected by the gap.

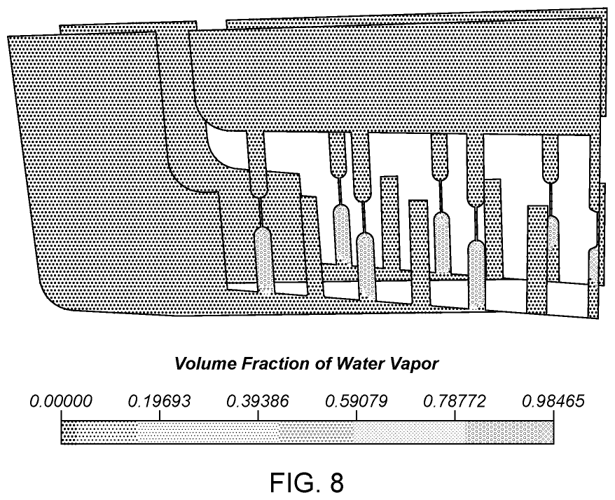

FIG. 8 shows a volume fraction of gas due to cavitation of the electrolyte as it exits the micro EDM pores shown in FIG. 7B.

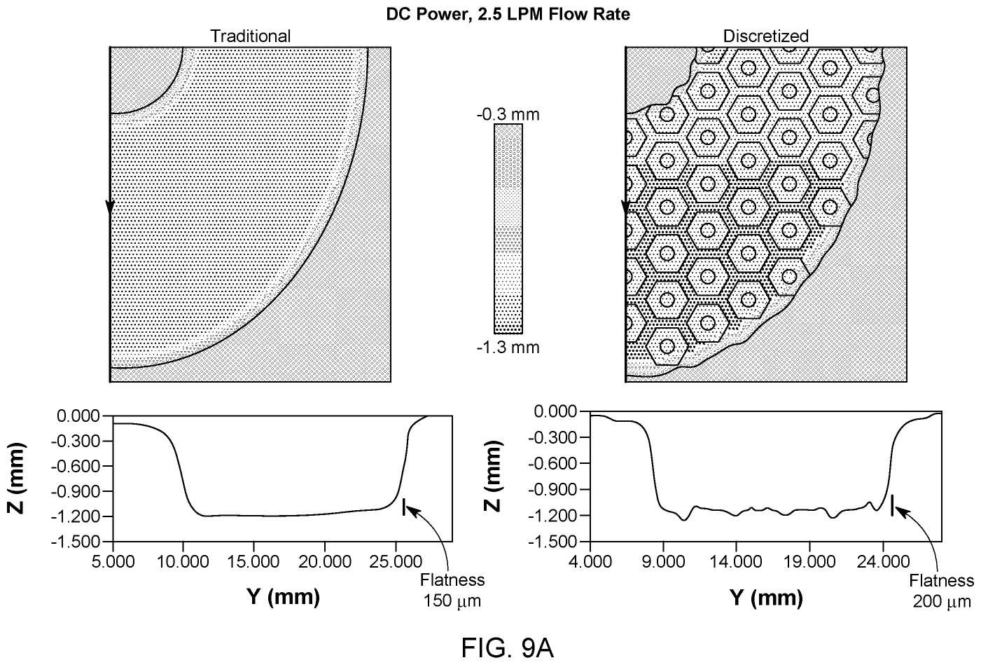

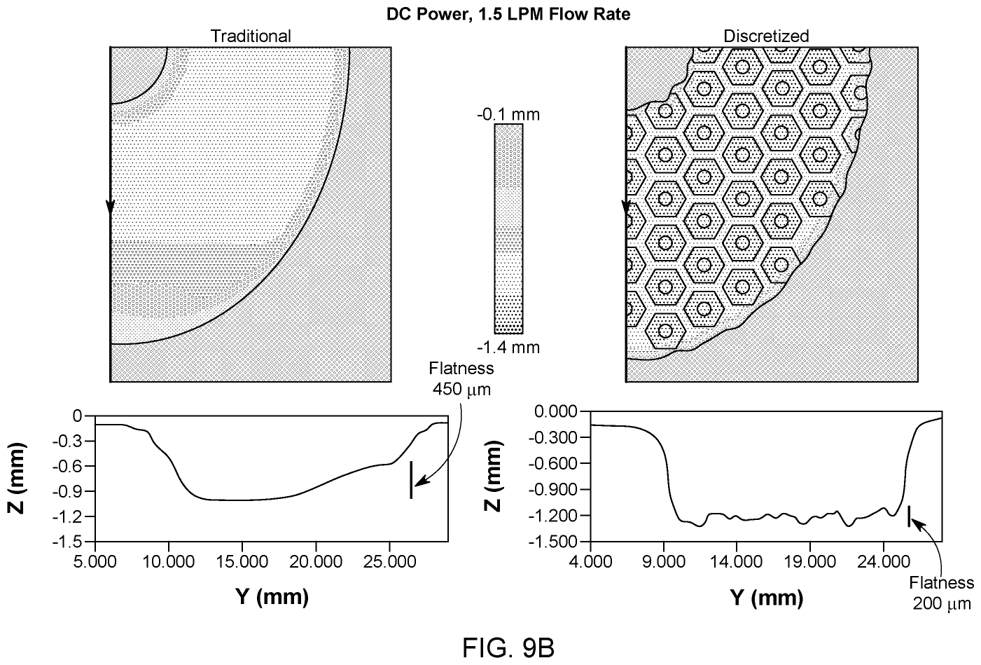

A comparison of the discretized-flow cathode described herein against a traditional center-flow cathode under identical processing conditions show the advantages of the discretized-flow cathode described herein. In embodiments of the discretized-flow tools and techniques described herein, a DC voltage profile may be used for the ECM process. FIGS. 9A and 9B show comparisons of the final workpiece surface for ECM using a traditional center-flow cathode and ECM using the discretized-flow cathode described herein using 20V DC power, a 200 μm targeted machining gap, and either a 2.5 lpm flow volume (shown in FIG. 9A) or a 1.5 lpm flow volume (shown in FIG. 9B). This illustrates the instability of the traditional center-flow cathode. While the machining at 2.5 lpm performs relatively well for the traditional case (only moderate flatness deviation of 150 μm, 3), when the flow is reduced to 1.5 lpm, the preference for flow to travel over the shorter distance causes instability and the electrolyte overheats (boils) in the longer section of travel. The boiling electrolyte loses conductivity and machining is therefore stalled resulting in a largely warped surface, and, if this were to occur in production, a shorted cathode. As can be seen from FIGS. 9A and 9B, in the case of ECM using a traditional cathode, machining may stall along the longer flow length, leading to the process not being completed. The profile shown below each 2D plot in FIGS. 9A and 9B represent the black line in each plot in the direction of the arrow.

The discretized-flow cathode described herein is, however, mostly unaffected by this change in flow volume. At some level of flow reduction, it may no longer be able to support the same machining speed, but it would not be prevented from machining entirely, whereas the closed-off flow to one particular area of the traditional center-flow cathode means that no matter how slowly it is machined, stability would never be regained, resulting in a process failure.

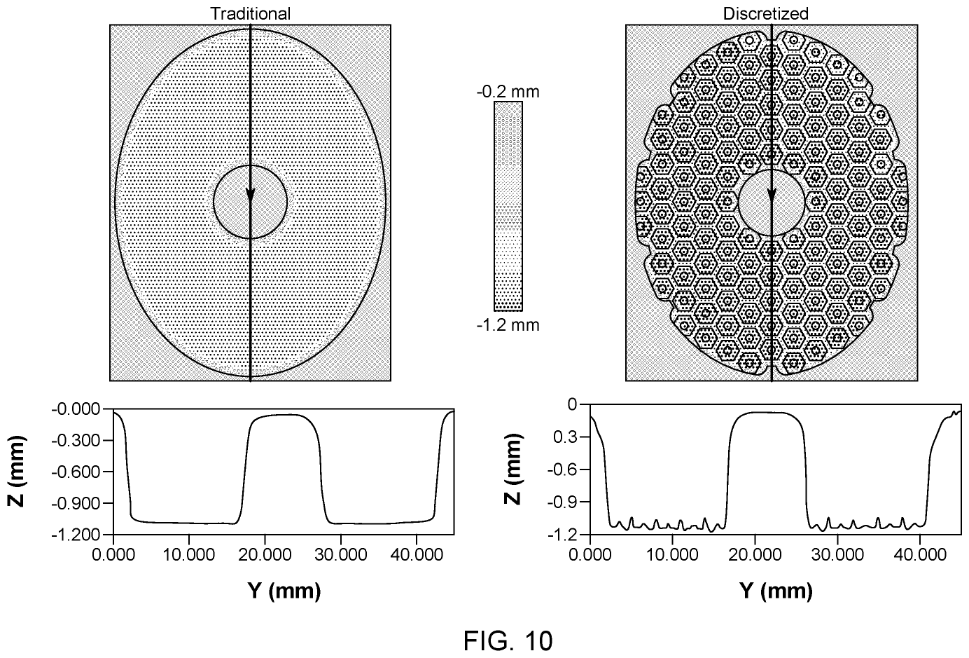

In embodiments of the discretized-flow tools and techniques described herein, a pulsed voltage profile may be used for the ECM process. FIG. 10 shows a comparison of a final workpiece surface for a traditional center-flow cathode and a discretized-flow cathode described herein using pulsed power, a 100 μm targeted machining gap, and 2 lpm flow volume. As shown in FIG. 10, the discretized-flow cathode may imprint the cathode surface on the workpiece. ECM using the traditional center-flow cathode maintains a slightly warped surface (less machining at the end of the flow path), while ECM using the discretized-flow cathode described herein is significantly cleaner in appearance and rather than over-machining at the hexagonal channel, the part is under-machined by ˜50 μm.

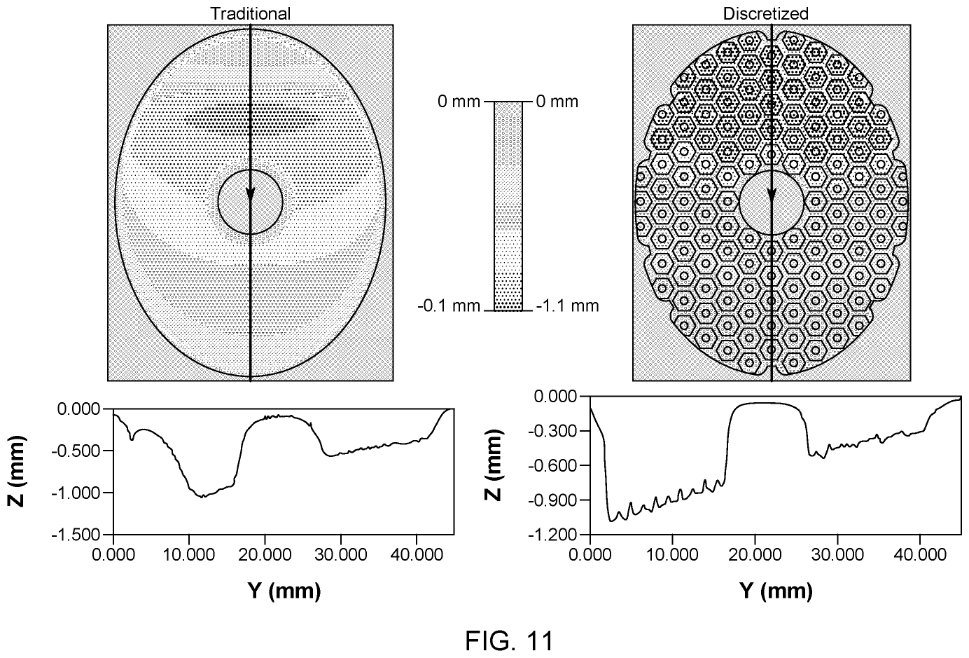

FIG. 11 shows a comparison of the final workpiece surface for a traditional center-flow cathode and a discretized-flow cathode using pulsed power, a 100 μm targeted machining gap, and 2 lpm flow volume with a 1.5-degree angle between the cathode machining face and the workpiece surface. Thus, the workpiece surface does not match the profile of the cathode surface.

In FIG. 11, the workpiece was positioned at a 1.5-degree angle to the cathode machining face, resulting in a machining gap that varies by 1 mm from end to end. In traditional ECM, this resulting machining gap requires thoughtful attention and complex fixturing to address. As shown in FIG. 11, with the discretized-flow tools and techniques described herein, machining proceeds as normal, even to the point that the machining rate is unaltered. In contrast, with the traditional concept, in the area of smallest gap, no machining occurs and the process cannot even begin.

The flow-discretization tools and techniques described herein may be used to fabricate turbine engine compressor blades and vanes, such as those on an integrally bladed rotor (IBR) or bladed disk (blisk), using a single ECM tool for both the roughing and the pre-finishing of the blades. In such an example, electrolyte flow is sourced from a single cavity and is evenly dispersed to all machining faces of the flow-discretization cathode, as described herein. The electrolyte is then evacuated through hexagonally interconnected channels to discretize the flow.

In one embodiment, flow-discretization may be used to make a roughing cathode, i.e., a cathode that is only used for hi-speed roughing.

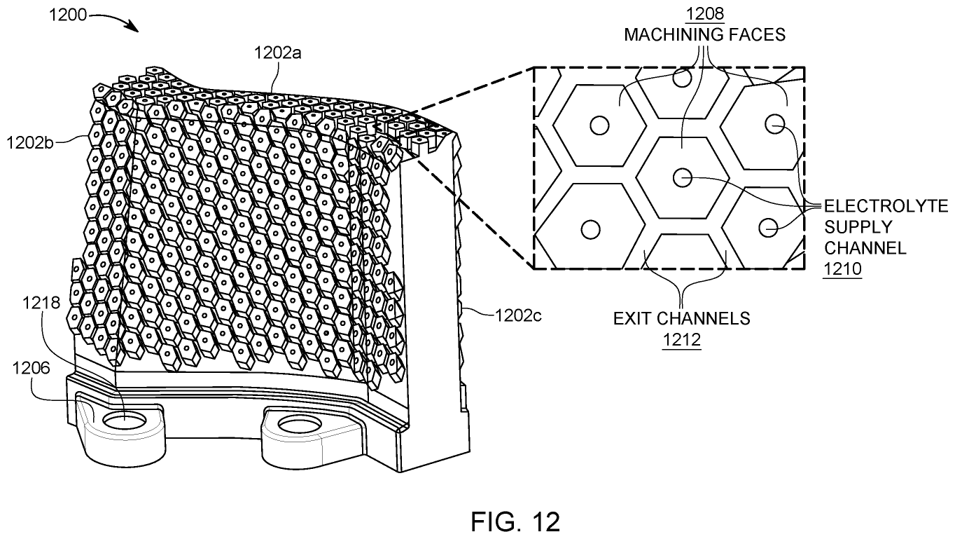

FIG. 12 shows an IBR-producing discretized-flow cathode with a hexagonal flow-discretization pattern. The discretized-flow cathode of FIG. 12 may be an “all-in-one” cathode.

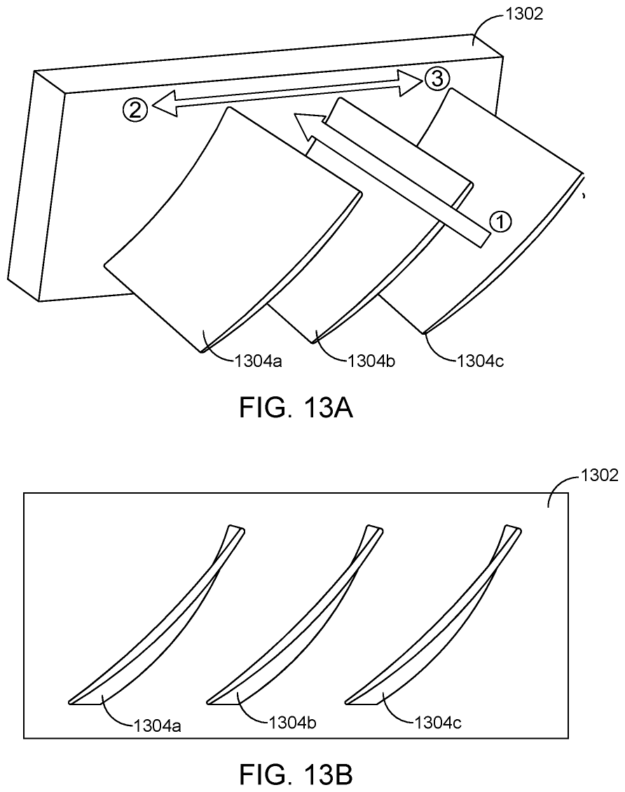

Referring to FIG. 12, the northern most section (machining face 1202a) of the cathode 1200 represents the roughing surface that is directly plunged to open the space between the two intended blades (i.e., the “1” movement shown in FIG. 13A), the broad face down the side (machining face 1202b) of the cathode 1200, and the backside (machining face 1202c) (not shown in detail in FIG. 12) represent the blade shaping sections of cathode 1200. The blown up inset in FIG. 12 shows the flow discretization sections 1208 (e.g., hexagonal sections) with the electrolyte inlet ports 1210 in the center (i.e., centrally located supply channels) and the exit channels 1212 between each discrete section of the machining face. In the embodiment shown in FIG. 12, the electrolyte flow inlet ports (or electrolyte supply holes) 1210 are circular, with a diameter of 0.5 mm. The channels 1212 in the electrolyte exit grid are rectangular, with a 0.5 mm width and 2 mm depth. The exemplary discretized-flow cathode 1200 of FIG. 12 is hollow internally, and all electrolyte is sourced from the same volume. In some embodiments, the electrolyte may be separated into multiple distinct sources (for example, three distinct sources) such that they can be turned on and off as needed for each machining face (e.g., each of machining faces 1202a-c). The machining face of each hexagon-shaped section 1208 has a nominal 2.5 mm width. The electrode 1200 further includes a base plate 1206 with fixturing holes 1218 for mounting to an ECM machine.

FIGS. 13A and 13B show a design of an exemplary workpiece that is cut as compressor IBR blades using a multi-faceted discretized-flow cathode with a single tool and no added flow fixturing. The workpiece is cut from a flat bar stock. In one embodiment, the flat bar stock is a 1.5″×2″×3″ block of Inconel 625. The multi-faceted discretized-flow cathode is designed to perform three distinct machining operations—a rough initial radial plunge (shown in FIG. 13A as cut “1”), followed by back and forth plunges along an axis normal the blade airfoil (shown in FIG. 13A as cuts “2” and “3”). These cuts are shown with directional arrows on FIG. 13A. Electrolyte distribution is controlled with an array of flow holes on all machining faces that act similarly to a flow manifold to sufficiently balance flow and prevent starvation at the actively machining faces.

An advantage of using the discretized-flow tools and techniques described herein is the simplicity of this approach. An all-in-one discretized-flow cathode may first rough out the blade by sinking axially into the bulk of the material, followed by two plunges in the perpendicular directions to finalize the blade. FIG. 13A shows the cutting path.

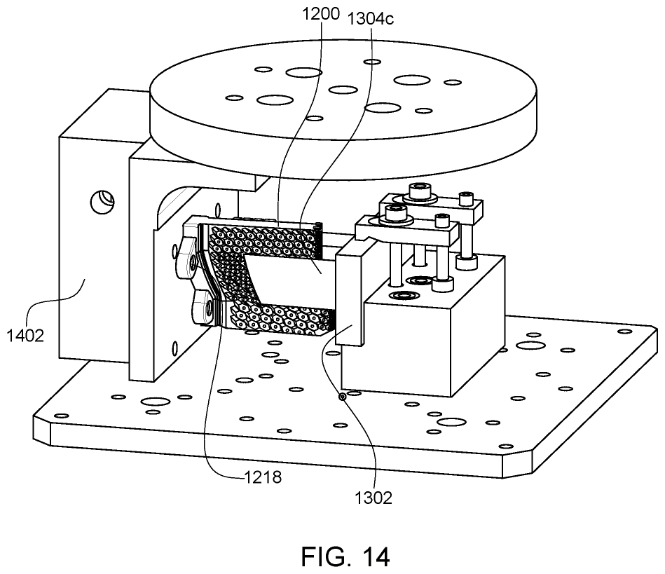

The flow-discretization tools and techniques described herein are advantageous in the simplicity of the fixturing required, which is in contrast to the complex and elaborate electrolyte flow set-ups found in many traditional ECM operations. FIG. 14 shows a fixture for the pieces shown in FIGS. 12 and 13A-13B. Referring to FIG. 14, the cathode 1200 and the required fixturing are shown. As shown in FIG. 14, the ECM cell cathode 1200 is attached to the fixturing plate with fixturing hole 1218 and positioned against the intended final workpiece 1302. The fixture shown in FIG. 14 includes an attached electrolyte reservoir 1402.

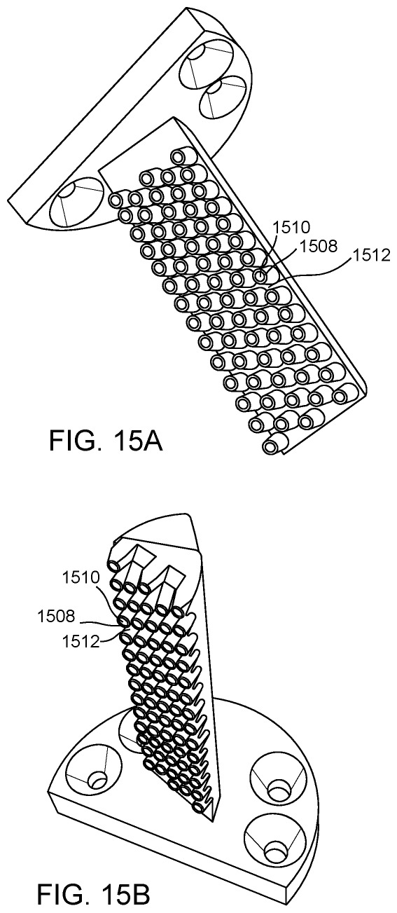

FIGS. 15A and 15B show an exemplary discretized-flow roughing cathode in different orientations. The discretized-flow tools and techniques described herein may be adapted for use in pure roughing applications where the priority is speed rather than profile tolerance. For example, in one embodiment, a discretized-flow cathode may be swept through a workpiece to rough out the blade shapes, using the IBR model shown in FIGS. 13A and 13B. Referring to FIGS. 15A and 15B, the machining face of the roughing cathode is divided into sections 1508, which flow inlets 1510 and exit channels 1512. The primary difference between the roughing discretized-flow cathode and the more generic discretized-flow cathode is that the leading faces 1508 for machining in the roughing discretized-flow cathode are not broad flat faces (as in the generic discretized-flow cathode), but instead are narrow ridges such that the foremost machining areas have only a short distance for the electrolyte to travel over in an attempt to increase process speed.

In the embodiment shown in FIGS. 15A and 15B, the electrolyte is sourced from an electrolyte source, such as an electrolyte reservoir internal to the tool or external to the tool, and it then flows to the machining face 1508 through 0.5 mm flow holes 1510 and exits through exit channels 1512. The leading edges of the machining face are arranged in a hexagonal pattern; however, the volume for the electrolyte exit 1510 is substantially larger in the roughing cathode shown in FIGS. 15A and 15B. In one embodiment, the roughing cathode shown in FIGS. 15A and 15B may be 3D-printed using a high level of definition in stainless steel 316L.

Because IBR blades are curved and twisted, multiple axes of motion are required to rough the shape while following the airfoil profile. This can be accomplished, for example, using the z and x linear axes of an ECM machine as well as a rotational axis.

Thus, in accordance with the discretized-flow tools and techniques disclosed herein, a metal fabrication system for performing electrochemical machining (ECM) is disclosed. The system comprises an ECM chamber, an ECM tool comprising a discretized-flow electrode, and an electrolyte source. The discretized-flow electrode may be manufactured using any known method of manufacturing, including, for example, being printed using additive manufacturing (i.e., 3D printing). The discretized-flow electrode includes a machining face divided into a plurality of sections separated at the machining face by an electrolyte exit channel. Each section includes an electrolyte flow passageway or inlet located centrally in the section. The electrolyte source is in fluid communication with the electrolyte flow inlets. In some embodiments, the system may further include a first fixturing plate for mounting the ECM tool for processing, a second fixturing plate for mounting a workpiece for processing, an electrolyte for use in performing the ECM processing, and a reservoir for holding the electrolyte.

The discretized-flow electrode described herein may be manufactured using any of the following methods: casting, including lost wax or ceramic core investment casting; sinker EDM, wire EDM, or hole drilling EDM; laser hole drilling or laser machining; CNC milling; electrochemical machining; photochemical etching; microfabrication techniques including etching (for example, focus ion beam (FIB), deep reactive ion etching (DRIE), and the like) and deposition (chemical or physical vapor deposition (CVD or PVC), plating, and the like); assemblies of components manufactured by the above techniques including cases where multiple components are bolted, brazed, diffusion bonded, welded, glued, or otherwise joined to create a discretized cathode design (for example, the assembly of needles illustrates this concept); additive manufacturing in polymer followed by plating of a conductive layer on the body of the additively manufactured polymer cathode; additive manufacturing in a metal or non-metal followed by infiltration of a metal or non-metal into the pores of the additively manufactured part to create a discretized cathode; additive manufacturing whereby different areas are either fully dense or porous to permit electrolyte or gas flow into or out of the gap; or any combinations of the above.

The discretized-flow tools and techniques described herein have multiple applications. For example, they may be used in applications for small, low-cost turbine engines. As an example of such an application, a single-piece cast Inconel 625 turbine nozzle may use the flow-discretization ECM processing described herein for processing of the airfoils.

As another example of applications for the discretized-flow tools and techniques described herein, they may be used in applications for large engine components for commercial or military engines. The flow-discretized ECM finishing processing described herein may be used, for example, on compressor or turbine vanes and blades for large engines. As explained above, tooling development cost and time is a barrier to broader use of ECM, and the flow-discretization ECM finishing process described herein may reduce that burden. Additionally, compressor blades may be processed from bar stock entirely with ECM, avoiding the cost and time associated with forging dies. Such an approach is beneficial for defense or sustainment activities where part volumes are low and large non-recurring engineering costs are difficult to justify.

As another example of applications for the discretized-flow tools and techniques described herein, they may be used in applications for blisks/integrally bladed rotors (IBRs). Many commercial engine titanium or nickel alloy blisks go through an ECM process as some stage of the manufacturing process. However, as explained above, tool design and iteration costs are a major challenge, and companies are eager to find ways to help reduce that burden. Such ECM operations rely on high volumes, expensive tool designs, and decades of experience to be successful. ECM is the fastest way to machine both titanium and nickel blisks; however, the economics are challenging, especially at lower volumes.

The flow-discretization tools and techniques for ECM processing disclosed herein may be used for power-generation turbines, rocket engine turbopumps, and automotive turbochargers. For example, flow-discretization tools and techniques for ECM may be used in turbine engine applications, which improves the manufacturing speed.

The flow-discretization tools and techniques for ECM processing described herein alleviate the challenge of a varying process starting condition, which is an issue in traditional ECM processing. With traditional ECM processing, a workpiece surface that is not conformal to the cathode surface requires thoughtful consideration and complex flow fixturing. Using the flow-discretization tools and techniques described herein, the process can run without any alterations to the processing conditions and no extra flow fixturing. This provides significant benefits for machining complex curved surfaces from material that is not net shaped.

In other embodiments, alternative discretization shapes, patterns, or designs may be used. The hexagonal pattern shown in the figures and described herein for flow discretization offers the benefits described herein. However, alternative shapes, designs, or patterns may be used, depending on the particular application for which the ECM tool is being built. For example, shapes such as squares or rectangles (e.g., in a grid pattern), triangles, or any other polygonal or non-polygonal shape may be used as a design or a pattern. Such shapes may be arranged in a honeycomb pattern, a concentric pattern (for example, a “fingerprint” style pattern with alternating offset patterns of inlets and outlets), a cubic subdivision pattern, or the like. The shapes, designs, or patterns may be repeating or non-repeating. The shapes may vary across the face or surface of the tool, such that various sections of the tool include varying shapes, designs, or patterns (e.g., there may be a mix of different discretization patterns across the machining face). The inlet and/or outlet features, spacing, and/or depth on the surface of the electrode may vary across the surface of the electrode. For example, the shapes, designs, or patterns may be three-dimensional in that the electrolyte inlets and/or outlets may be different depths relative to each other and not on the same local plane.

In some embodiments, the shapes, designs, or patterns may be created by using an automated script, artificial intelligence driven creation, and/or machine learning driven creation. In some embodiments, a CAD script that morphs the discretization pattern to fit a given surface area may be used to optimize the outcome. In some embodiments, an optimization program may be used to create a discretization design that embodies the concepts described herein, but with no discernable repeating pattern.

In some embodiments focused on roughing of material, the discretization pattern may be created using arrayed needles to provide a large outflow volume to support rapid machining. Given the simplicity of the flow, this type of geometry, when operated for simple hole drilling may be capable of >40 μm/s machining speeds. Thus, roughing operations of airfoils may be increased in speed by 2-3 times.

In one embodiment, the discretized-flow tools and techniques described herein may be used in a three-part process to manufacture a part/workpiece: (1) discretized-flow roughing; (2) pre-finishing; and (3) finishing. First, a roughing operation is performed on a portion of unfinished material to create an approximate shape of the workpiece. The roughing operation may be performed using a first discretized-flow ECM tool comprising a cathode having a plurality of electrolyte flow holes arranged in a pattern and a plurality of electrolyte exit channels dividing the electrolyte flow holes. Second, a pre-finishing operation is performed on the workpiece. The pre-finishing operation may be performed using a second discretized-flow ECM tool comprising a cathode having a plurality of electrolyte flow holes arranged in a pattern and a plurality of electrolyte exit channels dividing the electrolyte flow holes. Third, a finishing operation is performed on the workpiece. The finishing operation may be performed using any known finishing operation. In one embodiment, the finishing operation may use oscillatory pulsed electrochemical machining (OPECM), as described, for example, in international patent application number PCT/US2020/040819 filed by Voxel Innovations, Inc. In such an embodiment, a third discretized-flow ECM tool is used to perform the OPECM process. The third discretized-flow ECM tool used may comprise a cathode having a plurality of electrolyte flow holes arranged in a pattern and a plurality of electrolyte exit channels dividing the electrolyte flow holes. The OPECM process is performed to remove surface irregularities that on the workpiece by the discretized-flow pattern on the machining face of the cathode. In some embodiments, the ECM tool used for the roughing operation and the ECM tool used for the pre-finishing operation may be different tools, having different shapes, different flow discretization patterns, or other differences, or the like. Similarly, in some embodiments, the ECM tool used for the pre-finishing operation and the ECM tool use for the finishing operation may be different tools. In other embodiments, the ECM tool used for the pre-finishing operation and the ECM tool used for the finishing operation may be the same tool. In some embodiments, the pre-finishing or finishing tools may not be discretized, which allows for the removal of surface artifacts created from the geometry of the discretized electrode used in the roughing first step.

The description and figures provided above are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments.

Reference in this specification to “one embodiment” or “an embodiment” means that a particular feature, structure, or characteristic described in connection with the embodiment is included in at least one embodiment of the disclosure. Multiple appearances of the phrase “in one embodiment” in various places in the specification are not necessarily all referring to the same embodiment, nor are separate or alternative embodiments mutually exclusive of other embodiments. The various described features may be exhibited by some embodiments and not by others. Similarly, the various described requirements may be requirements for some embodiments but not for other.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure.

Alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given.

Unless otherwise defined, all technical and scientific terms used herein have the same meaning as commonly understood by one of ordinary skill in the art to which this disclosure pertains. In the case of conflict, the present document, including definitions, will control.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention described herein refer to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of performing discretized-flow electrochemical machining (ECM), the method comprising:
fabricating an ECM tool comprising a discretized-flow electrode,
wherein the discretized-flow electrode includes a machining face divided into a plurality of sections that separate flow of an electrolyte into multiple discrete areas of the discretized-flow electrode,
wherein the sections include a local electrolyte flow inlet, and wherein the sections are separated at the machining face by an electrolyte flow outlet channel that runs parallel to the machining face;
fixturing the ECM tool into an ECM machine, the ECM tool being positioned such that the machining face of the discretized-flow electrode is positioned to create a machining gap for processing a workpiece; and
processing the workpiece using the ECM machine with the ECM tool fixed into the ECM machine, wherein processing the workpiece includes circulating the electrolyte from an electrolyte source to the machining gap through the local electrolyte flow inlet and out through the local electrolyte flow outlet channel such that the electrolyte exits the machining gap approximately parallel to the surface of the machining face.

2. The method of claim 1, wherein the discretized-flow electrode is a roughing cathode, a pre-finishing cathode, or a finishing cathode.

3. The method of claim 1, wherein the electrolyte flow outlet channel provides a continuous pathway at the machining face.

4. The method of claim 1, wherein the sections of the machining face are geometrically shaped sections or are formed from a plurality of line segments to create a two-dimensional shape.

5. The method of claim 1, wherein the machining face is divided into a hexagonal grid.

6. The method of claim 1, wherein the discretized-flow electrode is 3D-printed using a conductive material.

7. The method of claim 1, wherein shapes of the sections of the machining face or patterns of the sections of the machining face are determined using an automated script or an artificial intelligence driven creation process based on the workpiece.

8. A system for performing electrochemical machining (ECM), the system comprising:
an ECM chamber;
an ECM tool comprising a discretized-flow electrode,
wherein the discretized-flow electrode includes a machining face divided into a plurality of sections that separate flow of an electrolyte into multiple discrete areas of the discretized-flow electrode,
wherein the sections of the machining face include a local electrolyte flow inlet, and
wherein the sections of the machining face are separated at the machining face by an electrolyte flow outlet channel that runs parallel to the machining face; and
an electrolyte source in fluid communication with the local electrolyte flow inlets of the sections of the machining face, wherein the electrolyte source provides the electrolyte to the ECM chamber through the local electrolyte flow inlets;
wherein the electrolyte flows from the sections of the machining face into an inter-electrode gap and escapes from the inter-electrode gap through the electrolyte flow outlet channel that separates the sections of the machining face, and
wherein the electrolyte flow outlet channel is configured to cause the electrolyte to exit the inter-electrode gap approximately parallel to the surface of the machining face.

9. The system of claim 8, wherein the discretized-flow electrode is a roughing cathode, a pre-finishing cathode, or a finishing cathode.

10. The system of claim 8, wherein the electrolyte flow outlet channel provides a continuous pathway at the machining face.

11. The system of claim 8, wherein the sections of the machining face are geometrically shaped sections or are formed from a plurality of line segments to create a two-dimensional shape.

12. The system of claim 8, wherein the machining face is divided into a hexagonal grid.

13. The system of claim 8, wherein the discretized-flow electrode is 3D-printed using a conductive material.

14. A discretized-flow electrode for performing electrochemical machining (ECM), the discretized-flow electrode comprising:
a machining face divided into a plurality of sections that separate flow of an electrolyte into multiple discrete areas of the discretized-flow electrode,
wherein the sections include a local electrolyte flow inlet, and
wherein the sections are separated at the machining face by an electrolyte flow outlet channel that runs parallel to the machining face;
wherein the machining face is configured such that electrolyte flows from the sections into an inter-electrode gap and escapes from the inter-electrode gap through the outlet channel that separates the sections of the machining face, and
wherein the electrolyte flow outlet channel is configured to cause the electrolyte to exit the inter-electrode gap approximately parallel to the surface of the machining face.

15. The discretized-flow electrode of claim 14, wherein an electrolyte is supplied to the electrolyte flow inlets in the sections of the machining face through electrolyte flow passages internal to the discretized-flow electrode.

16. The discretized-flow electrode of claim 14, wherein the discretized-flow electrode is a roughing cathode, a pre-finishing cathode, or a finishing cathode.

17. The discretized-flow electrode of claim 14, wherein the electrolyte flow outlet channel provides a continuous pathway at the machining face.

18. The discretized-flow electrode of claim 14, wherein the sections of the machining face are geometrically shaped sections or are formed from a plurality of line segments to create a two-dimensional shape.

19. The discretized-flow electrode of claim 14, wherein the machining face is divided into a hexagonal grid.

20. The discretized-flow electrode of claim 14, wherein the discretized-flow electrode is 3D-printed using a conductive material.
